(19) United States
(12) Patent Application Publication
(10) Pub. No.: US 2006/0289192 A1
(43) Pub. Date: Dec. 28, 2006

(54) Modular electrical outlet assembly

(76) Inventors: Kevin Johnson, Venice, FL (US); Brandon Yarborough, Venice, FL (US)

Correspondence Address: Charles J. Prescott, P.A., Suite 115, 2033 Wood Street, Sarasota, FL, 34237, US

(21) Appl. No.: 11/166,886

(22) Filed: Jun. 24, 2005

(51) Int. Cl. H01H 23/04

(52) U.S. Cl. 174/53

(57) ABSTRACT

A modular electrical outlet assembly including an outlet box having sides, a bottom, and an open end thereof adapted for attachment into a wall of a building. An outlet receptacle and a cover plate are formed together as a unit, the cover plate extending beyond the receptacle which is positionable within the outlet box. The receptacle has internal electrical conductors in alignment with two spaced arrays of plug-in apertures formed through the cover plate which are adapted to receive and come in electrical contact with the male prongs of an electric power cord plug. An attaching bracket is positioned and secured within the outlet box and includes spaced threaded apertures positioned opposite the open end of the outlet box. A ground aperture of each array is adapted to receive a male ground prong of the power cord plug and is aligned with a passage formed through the receptacle adapted to receive an elongated mounting fastener passing therethrough into threaded engagement with one threaded aperture whereby the receptacle is held within the outlet box with the cover plate held in position against the wall.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to electrical receptacle units and assemblies forming electrical outlets, and more particularly to a modular electrical outlet assembly which reduces the number of components and provides a smoother, less interrupted finished cover plate therefor.

2. Description of Related Art

With escalating volumes and costs of building and housing construction, the construction industry is ever seeking both cost and time saving building components and materials to help contain the cost of construction. A typical building or house will necessarily include several dozen, if not hundreds of electrical wall outlets which provide plug-in power for electrical appliances and the like. These electrical outlets typically include an outlet box which is attachable to the structure of the wall and fits between the wall outer surfaces, an outlet receptacle having electrical conductors therein which interconnect the prongs of an electric appliance male plug and the internal wiring which delivers electrical power to the electrical outlet assembly. A decorative or finished cover plate is then attached against the outer surface of the wall to conceal the outlet receptacle and the hole formed into the wall outer surface to provide clearance access around the electrical receptacle itself.

A number of prior art devices have been aimed at consolidating the number of components and/or installation ease and thus reducing the overall costs of these electrical outlet assemblies as follows:
U.S. Pat. No. 1,835,554 to Both
U.S. Pat. No. 3,437,737 to Wagner
U.S. Pat. No. 3,437,738 to Wagner
U.S. Pat. No. 3,488,428 to Smith
U.S. Pat. No. 2,437,802 to Adler
U.S. Pat. No. 2,265,890 to Bentley
U.S. Pat. No. 3,949,155 to Bourne
U.S. Pat. No. D347,622 to Flasz
U.S. Pat. No. 5,223,673 to Mason

U.S. Pat. No. 1,835,554 to Both discloses an electric receptacle comprising a body portion and a faceplate portion molded in one piece. Bentley, in U.S. Pat. No. 2,265,890, teaches a combined faceplate and receptacle.

Wagner is the inventor of modular electrical outlets as disclosed in U.S. Pat. Nos. 3,437,737 and 3,437,738 whose primary object is to provide quickly removable electrical modules.

A faceplate formed integral with the plug receptacle is taught by Grove in U.S. Pat. No. 3,885,852 and Bourne teaches unitary electrical receptacles or switches in U.S. Pat. No. 3,949,155. A design patent issued to Flasz, Des. 347,622, teaches a combined electrical outlet and cover plate.

The present invention provides a modular electrical outlet assembly which affords a sub-assembly of the outlet receptacle and the cover plate which are formed together as a unit. This sub-assembly is connectable into the outlet box which is previously anchored into the structure of the wall by conventional means. However, an additional bracket positioned and secured within the outlet box includes threaded apertures in alignment with the apertures formed through the cover plate which receive the ground prong of a three-prong electric power cord plug. The ground prong aperture extends through a passage formed through the outlet receptacle and an elongated threaded fastener is held for rotational threaded engagement into the threaded apertures of the bracket. After installation of the outlet receptacle and cover plate sub-assembly wherein the driving head of each of the elongated fasteners is buried at the bottom of the passage, the plug-in apertures, including the ground aperture, function normally to receive an electric power plug. By this arrangement, only the plug-in apertures formed through the cover plate interrupt the otherwise continuous finished surface of the cover plate. No additional apertures are required for threaded fasteners which otherwise conventionally attach the cover plate to the outlet receptacle and/or the outlet box.

### BRIEF SUMMARY OF THE INVENTION

This invention is directed to a modular electrical outlet assembly including an outlet box having sides, a bottom, and an open end thereof adapted for attachment into a wall of a building. An outlet receptacle and a cover plate are formed together as a unit, the cover plate extending beyond the receptacle which is positionable within the outlet box. The receptacle has internal electrical conductors in alignment with two spaced arrays of plug-in apertures formed through the cover plate which are adapted to receive and come in electrical contact with the male prongs of an electric power cord plug. A conductive attaching bracket is positioned and secured within the outlet box and includes spaced threaded apertures positioned opposite the open end of the outlet box. A ground prong aperture of each array is adapted to receive a male ground prong of the power cord plug and is aligned with a passage formed through the receptacle adapted to receive an elongated mounting fastener passing therethrough into threaded engagement with one threaded aperture whereby the receptacle is held within the outlet box with the cover plate held in position against the wall.

It is therefore an object of this invention to provide a modular electrical outlet assembly having a sub-assembly including an outlet receptacle and an outlet cover plate formed together as a unit.

Yet another object of this invention is to provide a modular electrical outlet assembly with a cover plate, the outer finished surface of which is only interrupted by the plug-in apertures required for receiving the male prongs of an electric power cord plug.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is a front elevation view of the invention.

FIG. 2 is a side elevation partially broken exploded view of the invention of FIG. 1.

FIG. 3 is an alternate embodiment of FIG. 2.

### DETAILED DESCRIPTION OF THE INVENTION

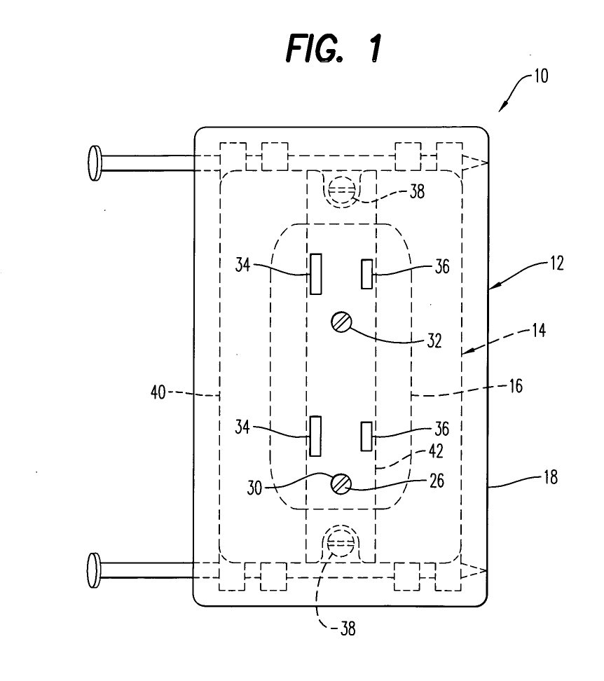

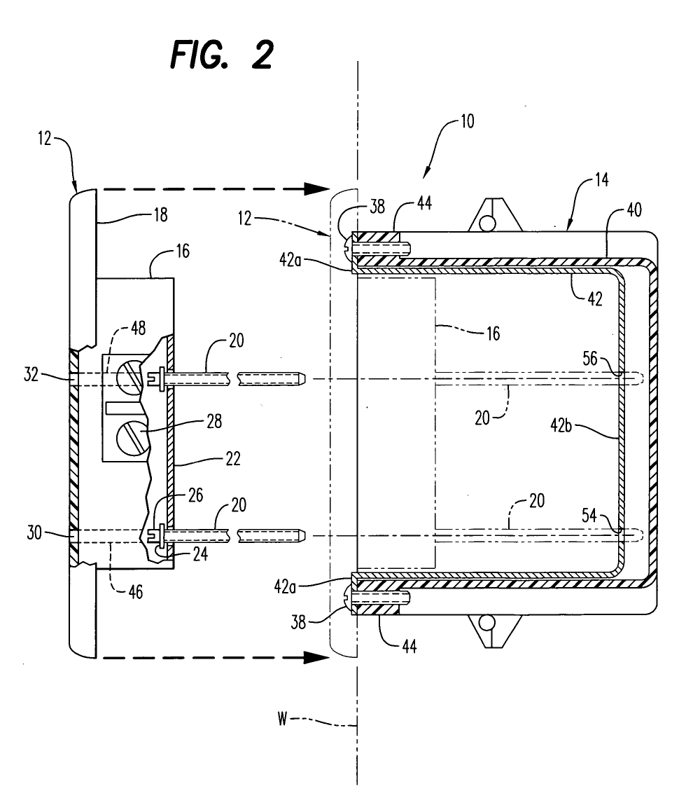

Referring now to the drawings, and firstly to FIGS. 1 and 2, the preferred embodiment of the invention is there shown generally at numeral 10. This embodiment 10 includes a modular or one-piece outlet receptacle sub-assembly 12, an outlet box 14 and an attaching bracket 42.

The outlet receptacle sub-assembly 12 is formed as a unit of preferably molded plastic exterior and includes the outlet receptacle 16 and a cover plate 18 which extends laterally in all directions from the rectangular perimeter of the outlet receptacle 16 for positioning against an outer wall surface W. The outlet receptacle 16 is of a conventional design including connecting screws 28 which facilitate attachment of the ground neutral and hot wires of a three-wire bundle (not shown) within the wall. The molded cover plate 18 includes a decorative flange as desired to facilitate flush tight engagement against the wall W surface.

The rearward wall 22 of the receptacle 16 includes spaced apart apertures formed therethrough which receive elongated threaded fasteners 20. These threaded fasteners 20 have reduced diameter driving head 26 sizes for installation ease with slots to receive a small flat bladed screw driver inserted therein for rotational movement thereof. Fibrous washers 24 are engaged against the driving heads 26 and are of sufficient size so as to prevent dislodgement or inadvertent removal of the fasteners 20 from aligned apertures 30 and 32 formed through the cover plate 18 as described herebelow.

In FIG. 1, the cover plate 18 is generally smooth, flat and uninterrupted except with respect to the three plug-in apertures 32/34/36 and 30/34/36 each of which form an array of plug-in apertures adapted in size and spacing to receive the male prongs of a conventional 110v. electric power cord plug. The ground prong apertures 30 and 32 are formed in alignment with a passageway 46 and 48, respectively, and the driving heads 26 of each of the corresponding elongated fasteners 20. By this arrangement, an elongated flat-bladed screw driver may be inserted into each of the ground prong apertures 30 and 32 to rotate the heads 26 for threadable installation of the threaded elongated shafts as will be described herebelow.

Again in the preferred embodiment 10 as best seen in FIG. 2 and shown in hidden lines in FIG. 1, the elongated attaching bracket 42 having a generally U-shaped configuration with flanges 42a formed at each distal end thereof is configured for positioning against the walls of the conventional outlet box 14. The outlet box 14 is of a conventional nature formed of molded plastic material such as that manufactured by Lamson and Sessions and distributed under the trademark CARLON which embodies all of the features described with respect to this invention.

The attaching bracket, preferably formed of a thin conductive strip of steel or aluminum material, again has a generally U-shape having threaded apertures 54 and 56 formed in the bottom wall 42b as seen in FIG. 2. Flanges 42a have mounting holes which receive fasteners 38 which threadably engage into bosses 44 of outlet box 14. Upon positioning of the sub-assembly 12 into the position shown in phantom, the elongated threaded fasteners 20 are threadably engaged into these threaded apertures 54 and 56, again as shown in phantom by the insertion of a narrow flat-blade screw drive through the ground apertures 30 and 32 to achieve the installed position shown in phantom in FIG. 2.

After installation, the passageways 46 and 48 also serve to receive the male ground prong of the conventional three-prong power cord plug to place the ground prong in proper electrical communication with the grounding components of the outlet receptacle 16 by contacting the driving head 26 of each of the threaded fasteners 20. Grounding of the power cord plug is thus achieved by contact of the distal tip of the ground prong (not shown). Against the head 26 of the conductive fastener 20 to the conductive bracket 42 and to fastener 38 to which a ground wire (not shown) is attached.

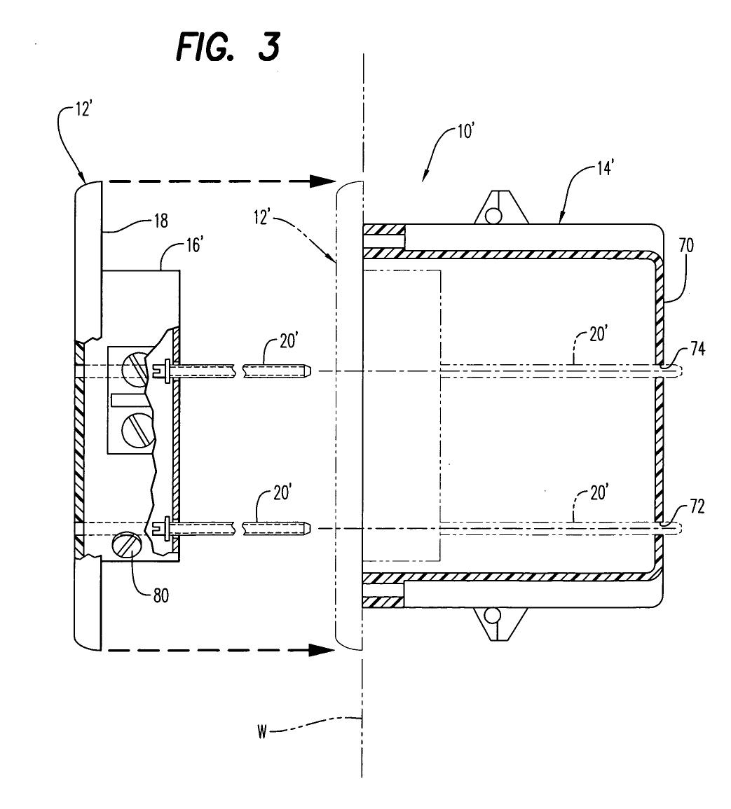

Referring now to FIG. 3, an alternate embodiment of the invention is there shown at numeral 10′ and is identical to that described in FIG. 2 except for the elimination of the attaching bracket 42. In this embodiment 10′, the threaded fasteners 20′ are somewhat longer than those previously described and the bottom 70 of the outlet box 14′ includes threaded or self-taping apertures 72 and 74 which serve to receive the threaded ends of the fasteners 20′ to effect attachment of the outlet receptacle sub-assembly 12 as previously described into the position shown in phantom against the wall surface W. Because the outlet box 14 or 14′ is of molded plastic and non-conductive, proper grounding is achieved by attachment of the ground wire (not shown) to the ground screw 80.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A modular electrical outlet assembly comprising:
an outlet box having sides, a bottom, and an open end thereof and being adapted for attachment into a wall of a building;
an outlet receptacle and a cover plate formed together as a unit, said cover plate extending beyond said receptacle and adapted to be positioned against the wall, said receptacle positionable within said outlet box through the open end thereof and having internal electrical conductors thereof;
said cover plate having two spaced arrays of plug-in apertures formed therethrough in alignment with corresponding said electrical conductors and being adapted to receive and come in electrical contact with the male prongs of an electric power cord plug;
an attaching bracket positionable within said outlet box, said bracket including spaced threaded apertures positioned opposite the open end of said outlet box;
a ground aperture of each of said arrays being adapted to receive a male ground prong of the power cord plug, each said ground aperture aligned with a passage formed through said receptacle and a corresponding said electrical conductor adapted to receive an elongated mounting fastener passing therethrough into threaded engagement with a corresponding said threaded aperture whereby said receptacle is held within said outlet box and said cover plate is held in position against the wall.

2. A modular electrical outlet assembly comprising:
a rectilinear outlet box having sides, a bottom, and an open end thereof and being adapted for attachment into a wall of a building;
an outlet receptacle and a cover plate formed together as a unit, said cover plate extending beyond said receptacle and adapted to be positioned against the wall, said receptacle having internal electrical conductors thereof and being positionable within said outlet box through the open end of said outlet box;
said cover plate having two spaced arrays of plug-in apertures formed therethrough in alignment with corresponding said electrical conductors and being adapted to receive and come in electrical contact with the male prongs of an electric power cord plug;
a generally U-shaped attaching bracket connectable within said outlet box, said bracket including spaced threaded apertures positioned opposite the open end of said outlet box adjacent to said bottom;
a ground aperture of each of said arrays being adapted to receive a male ground prong of the power cord plug, each said ground aperture aligned with a passage formed through said receptacle and a corresponding said electrical conductor adapted to receive an elongated mounting fastener passing therethrough into threaded engagement with a corresponding said threaded aperture whereby said receptacle is held within said outlet box and said cover plate is held in position against the wall.

3. A modular electrical outlet assembly comprising:
a generally rectangular outlet box having sides, a bottom, and an open end thereof and being adapted for attachment into a wall of a building with the open end outwardly facing;
an outlet receptacle and a cover plate formed together as a unit, said cover plate extending externally beyond said receptacle and having a rectangular shape adapted to be positioned against the wall, said receptacle positionable within said outlet box through the open end thereof and having internal electrical conductors thereof;
said cover plate having only two spaced arrays of plug-in apertures formed therethrough in alignment with corresponding said electrical conductors and being adapted to receive and come in electrical contact with the male prongs of an electric power cord plug, a ground aperture of each of said arrays being adapted to receive a male ground prong of the power cord plug, each said ground aperture aligned with a passage formed through said receptacle and a corresponding said electrical conductor;
an elongated threaded fastener positioned at a bottom of and rearwardly extending away from, said passage;
an attaching bracket secured within said outlet box, said bracket formed of conductive material and including spaced threaded apertures positioned opposite the open end of said outlet box in alignment with said passages and said threaded fasteners whereby said receptacle is held within said outlet box by said threaded fasteners, said cover plate is held in position against the wall and each ground prong is grounded by contact at a distal end thereof with a driving head of said fastener.

4. A modular electrical outlet assembly comprising:
an outlet box having sides, a bottom, and an open end thereof and being adapted for attachment into a wall of a building;
an outlet receptacle and a cover plate formed together as a unit, said cover plate extending beyond said receptacle and adapted to be positioned against the wall, said receptacle positionable within said outlet box through the open end thereof and having internal electrical conductors thereof;
said cover plate having two spaced arrays of plug-in apertures formed therethrough in alignment with corresponding said electrical conductors and being adapted to receive and come in electrical contact with the male prongs of an electric power cord plug;
said outlet box including spaced threaded apertures formed through said bottom opposite the open end of said outlet box;
a ground aperture of each of said arrays being adapted to receive a male ground prong of the power cord plug, each said ground aperture aligned with a passage formed through said receptacle and a corresponding said electrical conductor adapted to receive an elongated mounting fastener passing therethrough into threaded engagement with a corresponding said threaded aperture whereby said receptacle is held within said outlet box and said cover plate is held in position against the wall.

5. A modular outlet receptacle and cover plate for an electrical outlet assembly including an outlet box having sides, a bottom, and an open end thereof and being adapted for attachment into a wall of a building, comprising:
an outlet receptacle and a cover plate formed together as a unit, said cover plate extending beyond said receptacle and adapted to be positioned against the wall, said receptacle positionable within said outlet box through the open end thereof and having internal electrical conductors thereof;
said cover plate having two spaced arrays of plug-in apertures formed therethrough in alignment with corresponding said electrical conductors and being adapted to receive and come in electrical contact with the male prongs of an electric power cord plug;
an attaching bracket positionable within said outlet box, said bracket including spaced threaded apertures positioned opposite the open end of said outlet box;
a ground aperture of each of said arrays being adapted to receive a male ground prong of the power cord plug, each said ground aperture aligned with a passage formed through said receptacle and a corresponding said electrical conductor adapted to receive an elongated mounting fastener passing therethrough into threaded engagement with a corresponding said threaded aperture whereby said receptacle is held within said outlet box and said cover plate is held in position against the wall.
